(19) United States
(12) Patent Application Publication
(10) Pub. No.: US 2021/0262374 A1
(43) Pub. Date: Aug. 26, 2021

(54) ACOUSTIC VOLUME AND INSULATION IN HOT-END OF EXHAUST SYSTEMS

(71) Applicant: Faurecia Emissions Control Technologies, USA, LLC, Columbus, IN (US)

(72) Inventors: Thorsten Keesser, Augsburg (DE); James Egan, Indianapolis, IN (US); Catherine Guyard, Besançon (FR); Jean-Paul Brunel, Meslieres (FR)

(21) Appl. No.: 16/795,764

(22) Filed: Feb. 20, 2020

(51) Int. Cl. F01N 3/28; F01N 1/02; F01N 3/021; F01N 1/04

(52) U.S. Cl. CPC F01N 3/2885; F01N 1/023; F01N 3/0335; F01N 1/04; F01N 3/0211

(57) ABSTRACT

A vehicle exhaust system includes a component housing defining an internal cavity and at least one exhaust gas treatment element positioned within the internal cavity. A resonator volume is connected in parallel with the internal cavity via at least one resonator element and insulating material is located within the resonator volume.

### BACKGROUND

An exhaust system conducts hot exhaust gases generated by an engine through various exhaust components to reduce emissions, improve fuel economy, and control noise. Short exhaust systems, such as those encountered with hybrid vehicles or rear engine vehicles for example, often have insufficient volume and/or length to achieve a desired tailpipe noise level in combination with acceptable back pressure levels. Further, as gasoline particulate filter (GPF) technology emerges into the market, corresponding increases in exhaust system back pressure will need to be offset in order to avoid adverse effects on fuel economy or performance.

In addition to addressing issues raised by the introduction of GPF technology, other emerging powertrain technologies are requiring the industry to provide even more stringent noise reduction. The frequencies that need to be attenuated are being pushed to lower and lower frequencies not previously having to have been addressed. One traditional solution to attenuate such frequencies is to provide more internal volume; however, due to tight packaging constraints, the space required for such volume is not available. Another solution to attenuate these lower frequencies is to use valves; however, valves drive a higher back pressure at lower revolutions-per-minute, which is not always acceptable. As such, there is a need for unique acoustic solutions that are more efficient from a volume perspective and have less impact from a back pressure aspect.

### SUMMARY

In one exemplary embodiment, a vehicle exhaust system includes a component housing defining an internal cavity and at least one exhaust gas treatment element positioned within the internal cavity. A resonator volume is connected in parallel with the internal cavity via at least one resonator element and insulating material is located within the resonator volume.

In a further embodiment of the above, the resonator volume is formed between an outer surface of the component housing and an inner surface of a resonator housing that at least partially surrounds the component housing.

In a further embodiment of any of the above, an inlet cone is positioned at one end of the component housing and an outlet cone is positioned at an opposite end of the component housing, and wherein the at least one resonator element is located at one of the inlet and outlet cones.

In a further embodiment of any of the above, the at least one resonator element comprises a Helmholtz neck or a perforated portion of at least one of the inlet and outlet cones.

In a further embodiment of any of the above, there is no net flow out of the resonator volume.

In a further embodiment of any of the above, a second exhaust gas treatment element is positioned within the internal cavity and axially spaced from the first exhaust gas treatment element by a gap, and wherein the component housing is located in a hot end of the vehicle exhaust system and is immediately downstream of an engine or turbocharger.

In a further embodiment of any of the above, the at least one resonator element comprises at least one of a Helmholtz neck and perforated portion of the component housing.

In a further embodiment of any of the above, the component housing comprises a center housing portion that encloses the at least one gas treatment element, an inlet portion positioned at one end of the center housing portion, and an outlet portion positioned at an opposite end of the center housing portion, and wherein the at least one resonator element comprises at least one of a pipe or a perforated portion associated with at least one of the center housing portion, inlet portion, and outlet portion.

In a further embodiment of any of the above, the resonator volume is formed between an outer surface of the component housing and an inner surface of a resonator housing that completely surrounds the component housing, and wherein the insulating material completely fills the resonator volume.

In a further embodiment of any of the above, the resonator element is located in the inlet portion.

In a further embodiment of any of the above, the resonator volume is formed between an outer surface of the component housing and an inner surface of a resonator housing that completely surrounds the component housing, and wherein the insulating material only partially fills the resonator volume and is positioned at a location of the at least one resonator element.

In a further embodiment of any of the above, the resonator element is located in the inlet portion and including a perforated baffle positioned at a location between the inlet portion and the center housing portion to separate the resonator volume into an inlet volume at the inlet portion and a remaining volume, and wherein the insulating material only fills the inlet volume.

In a further embodiment of any of the above, the resonator element is located in the inlet portion and including a perforated baffle positioned at a location between the inlet portion and the center housing portion to separate the resonator volume into an inlet volume at the inlet portion and a remaining volume, and wherein a first portion of the insulating material fills the inlet volume and a second portion of the insulating material comprises a layer of insulating material that is attached to an inner surface of the center housing portion.

In a further embodiment of any of the above, the inlet portion comprises an inlet cone having an upstream end connected to an inlet pipe and a downstream end connected to the center housing portion, and wherein the downstream end has a greater outer dimension than the upstream end, and wherein the outlet portion comprises an outlet cone having an upstream end connected to the center housing portion and a downstream end connected to an outlet pipe, and wherein the upstream end has a greater outer dimension than the downstream end.

In a further embodiment of any of the above, a resonator housing is separate from the component housing and provides the resonator volume, and wherein the at least one resonator element comprises a pipe that connects the component housing to the resonator housing, and wherein the insulating material completely fills the resonator volume.

In a further embodiment of any of the above, a resonator housing is separate from the component housing and provides the resonator volume, and wherein the at least one resonator element comprises a pipe that connects the component housing to the resonator housing, and wherein the insulating material only partially fills the resonator volume and is located at a connection to the pipe.

In another exemplary embodiment, a vehicle exhaust system includes at least one exhaust gas treatment element and a component housing defining an internal cavity. The component housing comprises a center housing portion that encloses the at least one exhaust gas treatment element, an inlet cone positioned at an upstream end of the center housing portion, and an outlet cone positioned at a downstream end of the center housing portion. The component housing is located in a hot end of the vehicle exhaust system and is immediately downstream of an engine or turbocharger. A resonator volume is connected in parallel with the internal cavity via at least one resonator element, and there is no net flow out of the resonator volume. Insulating material is located within the resonator volume.

In a further embodiment of any of the above, the at least one resonator element comprises at least one of a pipe and a perforated portion of the component housing.

In a further embodiment of any of the above, a resonator housing is separate from the component housing and provides the resonator volume, and wherein the at least one resonator element comprises a pipe that connects the component housing to the resonator housing, and wherein the insulating material at least partially fills the resonator volume.

In a further embodiment of any of the above, a resonator housing completely surrounds the component housing such that the resonator volume is provided between an inner surface of the resonator housing and an outer surface of the component housing, and wherein the insulating material at least partially fills the resonator volume.

These and other features of this application will be best understood from the following specification and drawings, the following of which is a brief description.

### BRIEF DESCRIPTION OF THE DRAWINGS

FIG. 1 schematically illustrates a vehicle exhaust system.

FIG. 2 shows one example of a hot end component of the system of FIG. 1 and which includes a resonator element and insulating material.

FIG. 3 shows another example embodiment.

FIG. 4 shows another example embodiment.

FIG. 5 shows another example embodiment.

FIG. 6 shows another example embodiment.

FIG. 7 shows another example embodiment.

FIG. 8 shows another example embodiment.

FIG. 9 is a graph of transmission loss (dB) vs. frequency (Hz) that includes a comparison of a component with the resonator element and insulating material and a component without the insulating material.

FIG. 10 shows a bar graph of total back pressure (kPa) and graph of tailpipe noise (dB) vs. speed (rpm) for a component (a) without the resonator element and insulating material as compared to different configurations for components: (b) with a resonator neck, (c) with a perforated cone/resonator with insulating material, and (d) with a perforated cone/resonator that does not include insulating material.

### DETAILED DESCRIPTION

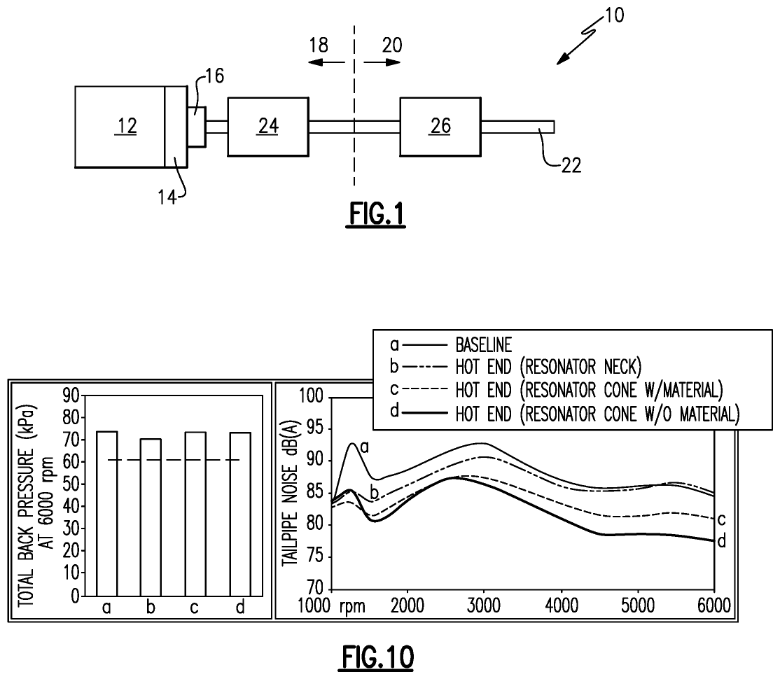

FIG. 1 shows a schematic representation of a vehicle exhaust system 10 that conducts hot exhaust gases generated by an engine 12 through various exhaust components to reduce emission and control noise as known. The engine 12 includes an exhaust manifold 14 that directs engine exhaust gases into an optional turbocharger 16. The exhaust system 10 includes a hot end 18 that is located immediately downstream of the exhaust manifold 14, or immediately downstream of the turbocharger 16 if included, and a cold end 20 that is downstream of the hot end 18. The exhaust gases exit to atmosphere via a tailpipe 22 at the cold end 20.

Exhaust gas operational temperatures at the hot end 18 are typically higher than exhaust gas operational temperatures at the cold end 20 due to the proximity of the engine 12. In one example, exhaust gas operational temperatures at the hot end can be within a range of 750-950 degrees Celsius. Under certain conditions, the operational temperatures may exceed 1000 degrees Celsius. In the cold end 20, as it is located further downstream of the engine 12 than the hot end 18, exhaust gas operational temperatures are lower, and in one example, are typically less than 650 degrees Celsius.

Exhaust components 24 at the hot end 18 can include, for example, exhaust gas treatment elements such as a diesel oxidation catalyst (DOC), a diesel particulate filter (DPF) and a selective catalytic reduction (SCR) catalyst or a gasoline particulate filter (GPF) and one or several three way catalysts (TWC) that are used to remove contaminants from the exhaust gas as known. Exhaust components 26 in the cold end 20 typically include, for example, noise attenuation components such as mufflers, resonators, etc. Exhaust gases pass from the hot end 18 into the cold end 20 and exit the exhaust system 10 via the tailpipe 22. The described exhaust components can be mounted in various different configurations and combinations dependent upon vehicle application and available packaging space.

It has been shown through testing and simulations that a Helmholtz Resonator, such as an acoustic volume of the order of two to four liters in communication with the exhaust flow via a neck pipe for example, that is positioned in the hot end 18 between a turbocharger outlet and an after-treatment element, or between after-treatment elements, provides an acoustic benefit about twice that of a similar amount of volume applied in the cold end 20 (downstream of the after-treatment section of the exhaust system 10) with little or no impact on back pressure. From a tailpipe noise perspective, positioning the Helmholtz resonator as close as possible to the engine 12 provides the best acoustic performance.

The subject disclosure packages one or more Helmholtz resonators at various locations in the hot end 18 of the system 10. For example, the resonator(s) could be located immediately after the exhaust manifold or turbocharger outlet but before the after-treatment elements, between the after-treatment elements, and/or immediately after the after-treatment elements. Various example configurations are discussed below and shown in the accompanying figures.

FIG. 2 shows one example of a hot end component 30 that is situated downstream of the exhaust manifold 14 and/or turbocharger 16, if applicable. The hot end component 30 includes a component housing 32 that defines an internal cavity 34. One or more exhaust gas treatment elements are positioned within the component housing 32. In one example, a first exhaust gas treatment element 36 is positioned within the internal cavity 34 and a second exhaust gas treatment element 38 is positioned within the internal cavity 34 downstream and axially spaced from the first exhaust gas treatment element 36 by a gap 40. The elements 36, 38 are held in place with insulating mats 28. In one example, the first 36 and second 38 exhaust gas treatment elements are SCR substrates.

A resonator volume 42, enclosed within a resonator housing 44, is coupled to be in parallel with the internal cavity 34 via a resonator element 46 that comprises a Helmholtz resonator, for example. In one example, the resonator housing 44 extends around the component housing 32. The resonator housing 44 can completely surround, or partially surround, the component housing 32. The resonator housing 44 can also be coaxial with the component housing 32 or offset (non-coaxial) from the component housing 32.

In one example, additional material 48 is located within the resonator volume 42. The additional material 48 can comprise, for example, fibrous material that is used for sound absorption and/or insulation. Any type of such material can be used; however, the material should be able to withstand high exhaust gas temperatures and corrosive/harsh environmental conditions. Examples of such materials are poly-crystalline wool (PCW), refractory ceramic fibers (RCF), alkaline silicate fibers, silica fibers, high temperature glass fibers, or glass fibers.

As such, the subject disclosure provides a dampened resonator comprising a parallel resonator volume 42 with fibrous material 48 that is closely situated next to a resonator element 46. Using the fibrous material dampens and broadens the Helmholtz resonance making the attenuation weaker but broader, which in certain conditions is preferable to providing a strong but sharp attenuation. Additionally, the fibrous material lowers an outer shell skin temperature and improves heat retention in the exhaust gas treatment element, which provides for improved emissions performance.

The component housing 32 receives exhaust gases from an inlet pipe 50 and directs treated exhaust gases to the cold end 20 via an outlet pipe 52. In one example, the component housing 32 includes a center housing portion 54 that encloses the first 36 and second 38 gas treatment elements, an inlet portion 56 that is positioned at one end of the center housing portion 54 and that connects to the inlet pipe 50, and an outlet portion 58 that is positioned at an opposite end of the center housing portion 54 and connects to the outlet pipe 52. In one example, the inlet 56 and outlet 58 portions comprise inlet and outlet cones.

In one example, the component housing 32 defines a center axis A and the inlet portion 56, first exhaust gas treatment element 36, second exhaust gas treatment element 38, and outlet portion 58 are coaxial with the center axis A.

In one example, the resonator housing 44 extends around the component housing 32 such that the resonator volume 42 is enclosed between an inner surface 60 of the resonator housing 44 and an outer surface 62 of the component housing 32. In one example, the resonator housing 44 includes a center housing portion 64 that surrounds the center housing portion 54 of the component housing 32, an inlet portion 66 that is positioned at one end of the center housing portion 64 to surround the inlet cone of the component housing 32, and an outlet portion 68 that is positioned at an opposite end of the center housing portion 64 to surround the outlet cone of the component housing 32. Thus, in this example, the resonator housing 44 generally matches a shape of the component housing 32. The housing 32, 44 can have any cross-sectional shape including circular, oval, elliptical, polygonal, etc.

As such, in some disclosed embodiments, the inlet portions 56, 66 and the outlet portions 58, 68 comprise inlet and outlet cones. The inlet cone 56 of the component housing 32 has an upstream end connected to the inlet pipe 50 and a downstream end connected to the center housing portion 54 wherein the downstream end has a greater outer dimension than the upstream end. The inlet cone 66 of the resonator housing 44 has an upstream end connected to the inlet pipe 50 and/or inlet cone 56 and a downstream end connected to the center housing portion 64 wherein the downstream end has a greater outer dimension than the upstream end. The outlet cone 58 of the component housing 32 has an upstream end connected to the center housing portion 54 and a downstream end connected to the outlet pipe 52 wherein the upstream end has a greater outer dimension than the downstream end. The outlet cone 68 of the resonator housing 44 has an upstream end connected to the center housing portion 64 and a downstream end connected to the outlet pipe 52 and/or outlet cone 58 wherein the upstream end has a greater outer dimension than the downstream end.

The at least one resonator element 46 couples the resonator volume 42 with the internal volume of the internal cavity 34 in a parallel configuration. In one example, the resonator element 46 comprises at least one of a perforated portion of the component housing 32 and a Helmholtz neck or pipe. FIGS. 2-8 show examples of different configurations for the resonator volume 42 and resonator element 46. In each of these different examples, the components are sealed such that there is no net flow in the resonator. Hot engine exhaust gas flows in through the inlet pipe 50, expands and slows down as the gas travels through inlet cone 56, and then passes through the exhaust gas treatment elements 36, 38. The exhaust gas exits the exhaust gas treatment elements 36, 38 and then expands into the outlet cone 58 before contracting and exiting through the outlet pipe 52.

The exhaust gas pressure pulsations from the engine travel down through the exhaust system 10 and are modified as they travel through the mechanisms of restriction, reflection, and absorption. When the pulsations reach the location of the resonator element 46 they cause the exhaust gas in the resonator element 46 to start moving. For low frequencies this gas can be considered as a lumped mass. The lumped mass of gas in the resonator element 46 compresses or rarifies the exhaust gas in the surrounding resonator volume 42. As the lumped mass of gas compresses the resonator volume 42, the volume pressure increases. As the lumped mass of gas rarifies, the volume pressure decreases. The result of this pressure is to push the lumped mass in the opposite direction to which it is travelling. In this way, the resonator volume 42 is acting as a spring and provides a spring-mass system with a tuned frequency. As there is no net flow through the resonator, and as the resonator element 46 comprises a side-branch arrangement, the impact on back pressure is negligible. This lack of flow in the resonator volume is also beneficial for retention of the insulating material 48. There will also be a positive effect on convection into the main gas volume. The fibrous material will work to broaden the tuned frequency of the resonator.

In the example of FIG. 2, the resonator element 46 comprises a Helmholtz pipe or neck 70 that is located at the inlet portion 56 of the component housing 32, and the resonator housing 44 completely surrounds the component housing 32. In this example, the resonator volume 42 is completely filled with the insulating material 48. In another example, the resonator volume 42 may only be partially filled with the insulating material 48. At least some of the material 48 should be closely situated to the resonator element 46.

One purpose of the material 48 is to absorb noise and the absorption will be particularly effective at high frequencies. Use of the material 48 will also broaden the attenuation of the Helmholtz resonator, which is tuned to much lower frequencies. It will provide an additional benefit of thermally insulating the resonator housing 44 from the heat of the first 36 and second 38 gas treatment elements. This thermal insulation will also result in an increase in the temperature of the component housing 32 and the substrate material of the first 36 and second 38 gas treatment elements such that the material can retain heat more effectively during less strenuous driving.

If additional retention is needed for the material 48, a perforated grid 72 on the neck 70 can be used. The perforated grid 72 comprises a flat structure with a plurality of openings and may cover an open end of the neck 70.

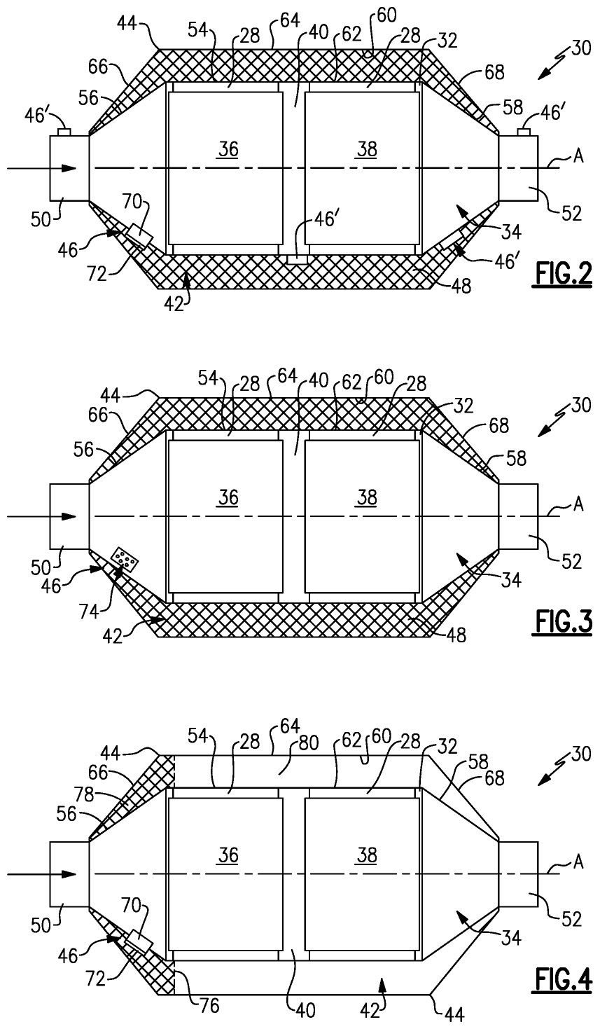

FIG. 3 is similar to FIG. 2; however, in this example the resonator element 46 that connects the acoustic resonator volume 42 to the flow in the internal cavity 34 is a perforated patch or opening 74. In the example of FIG. 3, this perforated opening 74 is located on the inlet portion 56, but the perforated opening 74 could be located in the center housing portion 54 between the substrates at the gap 40, in the outlet portion 58, or in the inlet 50 or outlet 52 pipes. The use of the perforated opening 74 may provide attenuation that is slightly broader than that of a neck. The perforated opening 74 is comprised of many small perforates that can be considered lumped together as a short neck of some area equivalent to that of a summed perforate area, and in this way it may be regarded as a Helmholtz resonator.

FIG. 4 shows a similar configuration as FIG. 2, but in this example a baffle 76 is used to contain the fibrous material 48 to a limited area of the resonator volume 42. The fibrous material 48 should be located at a place of higher acoustic velocity to maximize its acoustic benefit. By localizing the fibrous material, cost benefits can be realized over filling the entire acoustic volume; however, the thermal benefits will be reduced. In this example, the resonator element 46 is located in the inlet portion 56 and comprises a neck 70. The perforated baffle 76 is positioned at a location between the inlet portion 56 and the center housing portion 54 to separate the resonator volume 42 into an inlet volume 78 at the inlet portion 56 and a remaining volume 80. The material 48 only fills the inlet volume 78 and the remaining volume 80 is open.

FIG. 5 shows a similar configuration as FIG. 3 but like in FIG. 4 the fibrous material 48 is localized to a specific area of the resonator volume 42 by the perforated baffle 76. In this example, the resonator element 46 is located in the inlet portion 56 and comprises a perforated patch or opening 74. The perforated baffle 76 separates the resonator volume 42 into the inlet volume 78, which includes the material 48, and the remaining volume 80 that is open.

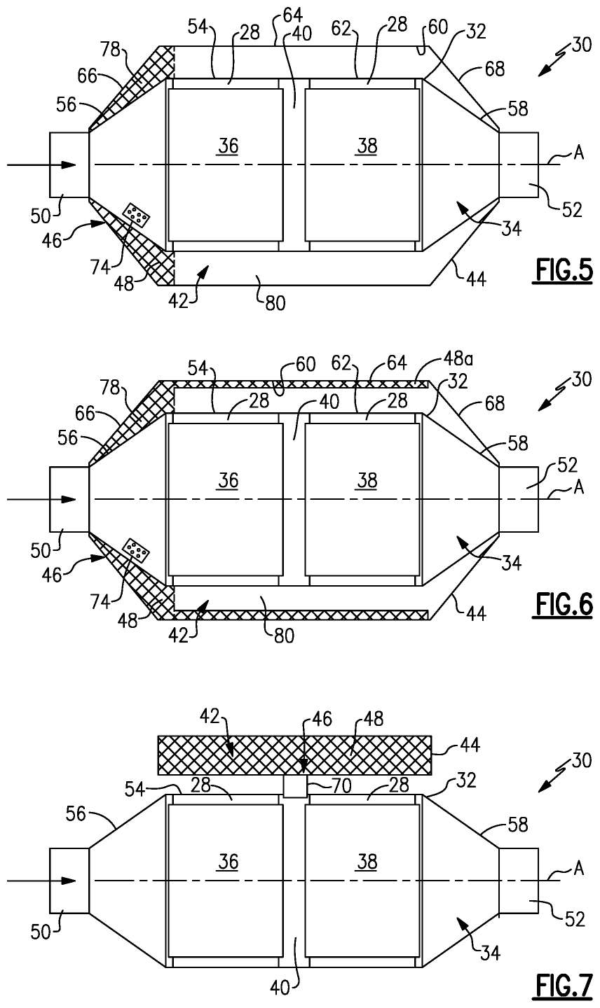

FIG. 6 is the same as FIG. 5 except that an additional layer of fibrous material 48a is added to the inner surface 60 of the resonator housing 44 within the remaining volume 80. Optionally, the material 48a could be located around an outer surface of the resonator housing 44. The purpose of this additional material 48a is more for thermal insulation than acoustics. In this example, the additional layer of material 48a is attached to the center housing portion 54 of the component housing 32.

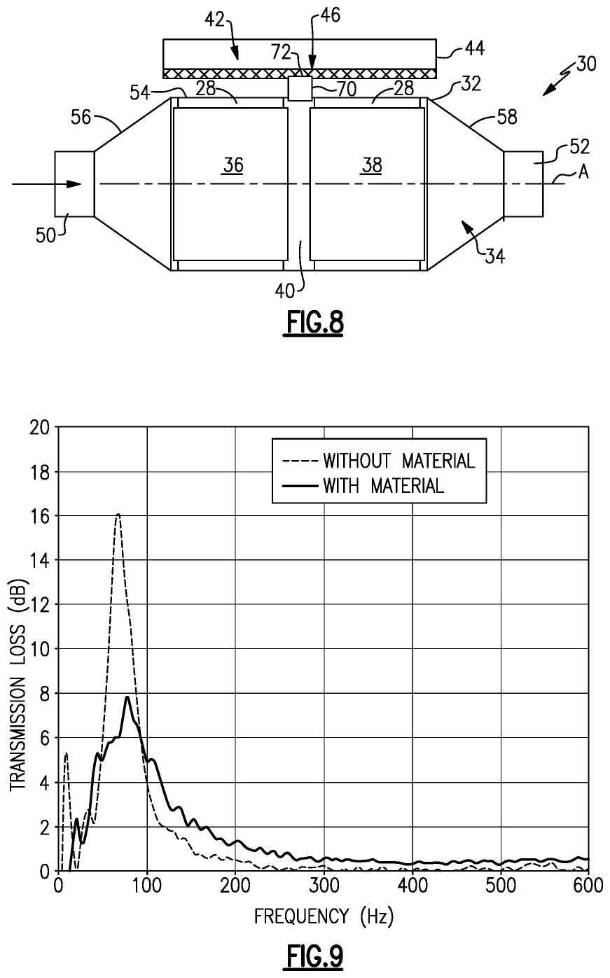

FIGS. 7 and 8 have the resonator volume 42 removed from around the component housing 32 to be above the housing. The resonator volume 42 could also be located at other locations relative to the component housing 32; however, as a top of the after-treatment component is hotter than the bottom, and as the vehicle body is typically above the housing 32, this location allows the resonator volume 42 to act as a shield. In FIG. 7, the resonator volume 42 is completely filled with fibrous material 48. In FIG. 8, a localized area is covered with a layer of fibrous material 48. In both configurations, the fibrous material 48 provides acoustic and thermal benefits.

In the examples shown in FIGS. 7 and 8, the resonator housing 44 is separate from the component housing 32 and provides the resonator volume 42. The resonator element 46 comprises a Helmholtz pipe or neck 82 that connects the component housing 32 to the resonator housing 44. In this example, the neck 82 connects to the center housing portion 54 at a location that radially overlaps the gap 40.

FIGS. 2-8 show different examples of the resonator element 46. The resonator element 46 can be used in any number, and in any combination, as needed to provide the desired acoustic effect. Further, the location of the resonator element 46 can be varied as needed. For example, the resonator element could be located in the inlet pipe, outlet pipe, inlet cone, center housing portion, or outlet cone, or any combination thereof. See resonator element 46′ for optional locations in FIG. 2. These optional locations can be used in any number, and in any combination, for the disclosed embodiments. The resonator element 46 connects to a parallel resonator volume 42 that includes fibrous material 48 for improved acoustic and thermal performance.

FIG. 9 shows the acoustic effect of the combination of the resonator volume and fibrous material 48. The dashed line shows a normal Helmholtz resonator without the additional material 48. The solid line shows the resonator with the additional material 48. The resonance is significantly dampened as the height of the peak is reduced. The resonance is also broader as there is more attenuation at a broader range of frequencies away from the resonance.

FIG. 10 shows the acoustic effect (a tailpipe noise comparison) of an acoustic volume connected to the hot end via a resonator neck (b) or a perforated cone (c)—with material 48 and a perforated cone (d) without material 48—compared to a baseline hot end (a). The partial pack acoustic performance (partially filled with material 48) is almost identical to fully packed performance (completely filled with material 48). This means that the amount of material 48 can be optimized for thermal benefit vs cost. Not having any material provides acoustic benefits but lacks the thermal benefits. FIG. 10 also shows that the back pressure remains basically unchanged with the different examples.

As discussed above, a resonator volume 42 that is closely coupled to the engine is more efficient and effective than the same volume added to a muffler in the middle or rear of the exhaust system. Typically, 3 or 4 liters added to the hot end is about as effective as 6 to 8 liters in the cold end. The subject disclosure uses necks or perforated housing portions to provide an acoustic volume in the hot end that forms a Helmholtz resonator. The neck dimensions (length and diameter) and acoustic volume determine a tuned frequency. When a volume surrounds a perforated portion, the perforates are the neck of the Helmholtz resonator. The perforates can be tuned more broadly than the neck configuration.

As Helmholtz resonators are tuned to lower frequencies (by making the neck of the resonator to have a smaller diameter or a longer length) their resonances become increasingly sharp. This makes them useful over a decreasingly small engine speed range. The use of the additional material in the acoustic volume provides a damping effect and reduces the sharpness effect. The use of the additional material also provides thermal benefits in addition to acoustic benefits. The material can be used to hold substrates in place, to insulate the substrates such that the substrates heat up quickly (good for light-off) and retains temperatures with less heat input, and to reduce external temperatures of components.

Thus, the subject disclosure combines a tuning resonator element 46 for acoustic attenuation in a component in the hot end 18 of the exhaust system 10 with fibrous material 48 that is located within the resonator volume 42 to provide further acoustic and/or thermal benefits. This combination results in improved acoustic efficiency with negligible back pressure impact resulting in tailpipe noise/acoustic volume improvement.

Although various embodiments have been disclosed, a worker of ordinary skill in this art would recognize that certain modifications would come within the scope of this invention. For that reason, the following claims should be studied to determine the true scope and content of this invention.

1. A vehicle exhaust system comprising:
a component housing defining an internal cavity;
at least one exhaust gas treatment element positioned within the internal cavity;
a resonator volume connected in parallel with the internal cavity via at least one resonator element; and
insulating material located within the resonator volume.

2. The vehicle exhaust system according to claim 1, wherein the resonator volume is formed between an outer surface of the component housing and an inner surface of a resonator housing that at least partially surrounds the component housing.

3. The vehicle exhaust system according to claim 1, including an inlet cone positioned at one end of the component housing and an outlet cone positioned at an opposite end of the component housing, and wherein the at least one resonator element is located at one of the inlet and outlet cones.

4. The vehicle exhaust system according to claim 3, wherein the at least one resonator element comprises a Helmholtz neck or a perforated portion of at least one of the inlet and outlet cones.

5. The vehicle exhaust system according to claim 1, wherein there is no net flow out of the resonator volume.

6. The vehicle exhaust system according to claim 1, including a second exhaust gas treatment element positioned within the internal cavity and axially spaced from the first exhaust gas treatment element by a gap, and wherein the component housing is located in a hot end of the vehicle exhaust system and is immediately downstream of an engine or turbocharger.

7. The vehicle exhaust system according to claim 1, wherein the at least one resonator element comprises at least one of a Helmholtz neck and perforated portion of the component housing.

8. The vehicle exhaust system according to claim 1, wherein the component housing comprises a center housing portion that encloses the at least one gas treatment element, an inlet portion positioned at one end of the center housing portion, and an outlet portion positioned at an opposite end of the center housing portion, and wherein the at least one resonator element comprises at least one of a pipe or a perforated portion associated with at least one of the center housing portion, inlet portion, and outlet portion.

9. The vehicle exhaust system according to claim 8, wherein the resonator volume is formed between an outer surface of the component housing and an inner surface of a resonator housing that completely surrounds the component housing, and wherein the insulating material completely fills the resonator volume.

10. The vehicle exhaust system according to claim 9, wherein the resonator element is located in the inlet portion.

11. The vehicle exhaust system according to claim 8, wherein the resonator volume is formed between an outer surface of the component housing and an inner surface of a resonator housing that completely surrounds the component housing, and wherein the insulating material only partially fills the resonator volume and is positioned at a location of the at least one resonator element.

12. The vehicle exhaust system according to claim 11, wherein the resonator element is located in the inlet portion and including a perforated baffle positioned at a location between the inlet portion and the center housing portion to separate the resonator volume into an inlet volume at the inlet portion and a remaining volume, and wherein the insulating material only fills the inlet volume.

13. The vehicle exhaust system according to claim 11, wherein the resonator element is located in the inlet portion and including a perforated baffle positioned at a location between the inlet portion and the center housing portion to separate the resonator volume into an inlet volume at the inlet portion and a remaining volume, and wherein a first portion of the insulating material fills the inlet volume and a second portion of the insulating material comprises a layer of insulating material that is attached to an inner surface of the center housing portion.

14. The vehicle exhaust system according to claim 8, wherein the inlet portion comprises an inlet cone having an upstream end connected to an inlet pipe and a downstream end connected to the center housing portion, and wherein the downstream end has a greater outer dimension than the upstream end, and wherein the outlet portion comprises an outlet cone having an upstream end connected to the center housing portion and a downstream end connected to an outlet pipe, and wherein the upstream end has a greater outer dimension than the downstream end.

15. The vehicle exhaust system according to claim 1, including a resonator housing that is separate from the component housing and provides the resonator volume, and wherein the at least one resonator element comprises a pipe that connects the component housing to the resonator housing, and wherein the insulating material completely fills the resonator volume.

16. The vehicle exhaust system according to claim 1, including a resonator housing that is separate from the component housing and provides the resonator volume, and wherein the at least one resonator element comprises a pipe that connects the component housing to the resonator housing, and wherein the insulating material only partially fills the resonator volume and is located at a connection to the pipe.

17. A vehicle exhaust system comprising:
at least one exhaust gas treatment element;
a component housing defining an internal cavity, wherein the component housing comprises a center housing portion that encloses the at least one exhaust gas treatment element, an inlet cone positioned at an upstream end of the center housing portion, and an outlet cone positioned at a downstream end of the center housing portion, and wherein the component housing is located in a hot end of the vehicle exhaust system and is immediately downstream of an engine or turbocharger;
a resonator volume connected in parallel with the internal cavity via at least one resonator element, wherein there is no net flow out of the resonator volume; and
insulating material located within the resonator volume.

18. The vehicle exhaust system according to claim 17, wherein the at least one resonator element comprises at least one of a pipe and a perforated portion of the component housing.

19. The vehicle exhaust system according to claim 17, including a resonator housing that is separate from the component housing and provides the resonator volume, and wherein the at least one resonator element comprises a pipe that connects the component housing to the resonator housing, and wherein the insulating material at least partially fills the resonator volume.

20. The vehicle exhaust system according to claim 17, including a resonator housing that completely surrounds the component housing such that the resonator volume is provided between an inner surface of the resonator housing and an outer surface of the component housing, and wherein the insulating material at least partially fills the resonator volume.
